(19) United States
(12) Patent Application Publication
(10) Pub. No.: US 2017/0289282 A1
(43) Pub. Date: Oct. 5, 2017

(54) FINDING COMMONALITY AMONG SOCIALLY AGGREGATED CONTEXTUAL INFORMATION

(71) Applicant: Lenovo (Singapore) Pte. Ltd., Singapore (SG)

(72) Inventors: Rod D. Waltermann, Rougemont, NC (US); John Carl Mese, Cary, NC (US)

(21) Appl. No.: 15/083,714

(22) Filed: Mar. 29, 2016

(51) Int. Cl. H04L 29/08; G06Q 10/10; G06F 17/30

(52) U.S. Cl. CPC H04L 67/22; G06F 17/3064; G06Q 10/1095

(57) ABSTRACT

One embodiment provides a method, including: accessing, using a processor, contextual data sources specific to a linked group of users; identifying, using a processor, an objective for the linked group of users; determining, based on the objective, a common factor among the linked group of users based on the contextual data sources; and providing, based on the common factor, a suggestion associated with achieving the objective. Other aspects are described and claimed.

### BACKGROUND

Scheduling a meeting location when you have several folks with preferred locations, or selecting a group gift for a friend can be a challenge. There are many factors to consider, for example, food allergies, likes and dislikes, travel preferences, etc., all of which add to the complexity scheduling a meeting for a group, selecting a group gift, etc.

Users operate their personal electronic devices for calendaring, making purchases, making travel plans, expressing interests on social media, consuming media and the like. Because these personal electronic devices are used so frequently, they offer a rich source of contextual data. For example, a user may operate his or her smart phone to “like” posts on social media, schedule appointments for work and personal activities, or even watch particular television shows or movies. This contextual data in turn offers a window or view of what the particular user is concerned with, likes, needs or prefers.

### BRIEF SUMMARY

In summary, one aspect provides a method, comprising: accessing, using a processor, contextual data sources specific to a linked group of users; identifying, using a processor, an objective for the linked group of users; determining, based on the objective, a common factor among the linked group of users based on the contextual data sources; and providing, based on the common factor, a suggestion associated with achieving the objective.

Another aspect provides a device, comprising: a processor; and a memory device that stores instructions executable by the processor to: access contextual data sources specific to a linked group of users; identify an objective for the linked group of users; determine, based on the objective, a common factor among the linked group of users based on the contextual data sources; and provide, based on the common factor, a suggestion associated with achieving the objective.

A further aspect provides a product, comprising: a storage device having code stored therewith, the code being executable by a processor and comprising: code that accesses contextual data sources specific to a linked group of users; code that identifies an objective for the linked group of users; code that determines, based on the objective, a common factor among the linked group of users based on the contextual data sources; and code that provides, based on the common factor, a suggestion associated with achieving the objective.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example of obtaining contextual data from a linked group of users.

FIG. 4 illustrates an example of using contextual data to identify a commonality among the linked group of users and make a suggestion relating to the linked group of users.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Conventionally, in order to arrive at a consensus choice for a meeting time, a location for an event, a group present, etc., discussions take place and everyone is asked his or her preference, e.g., via email, voice call, social networking, etc. These channels have become the primary mechanism of communicating. While there are electronic gift registries and wish lists, no particular method of arriving at a consensus on such group efforts has become dominant. This is because each conventional technique still requires effort from someone on the team to be the coordinator.

Online services might suggest what other things users of a particular product or service also like, but the relevancy of such suggestions may be weakly related to the group of people in question, i.e., such services do not take into account contextual history and preferences of the particular group of users.

An embodiment therefore leverages multiple data sources to aggregate contextually appropriate information that would inform or suggest a decision for a linked of group users. A group of users may link together in an opt-in fashion to allow a service to access to various data sources (e.g., social media accounts, device messages, etc.) to gather contextual data. The aggregation of the users' contextual data sources therefore is a voluntary, electable connection, which may be customized according to a user's preferences. The access to a user's contextual data may be tiered, such as permitting certain data sources to be used for certain linked groups, e.g., a business association verses a family group.

Once identified, these contextual data sources are mined and correlated across the linked group of users. An embodiment then finds intersections based on common interests, locations, habits, etc. These intersections are used to provide a set of suggestions, e.g., when a member of the linked group asks for a commonality or specific suggestion. For example, a user may ask for a meeting location for a particular group of users. As another example, a user may receive a suggestion for a location when an event is automatically triggered, e.g., a calendar reminder for an upcoming birthday is triggered on a user's device.

By way of illustrative example, an embodiment may assist in scheduling a meeting location when participants are in different buildings or different floors or are even remotely located. The participant locations can be considered along with the users' respective calendar data to identify a suggested time and place for the group meeting. For example, a user's calendar may indicate that a particular user has a lot of meetings and thus an inference may be made that this user needs a location that is relatively close to a prior meeting, e.g., in order to make adjacent meetings on time. In contrast, another user's calendar data may indicate that this user is less busy on a particular day, and thus an inference may be made that this other user can afford to travel more widely.

As another non-limiting example, in suggesting a group gift for a user, an embodiment may access contextual data to assist the group in selecting a gift for a member of the group. The contextual data used may include user specific historical data (such as social media data indicating that the user has read a book in a series), user specific preference data (e.g., a streaming service that indicates this particular user likes Sci-Fi movies) and socially aggregated information (e.g., crowd-sourced ratings or buzz on a trending product likely of interest to the particular user).

An embodiment may suggest a restaurant that a group could meet at, e.g., by taking in to account such data as food preferences of group members, food allergy information of group members, and travel distances for group members based on their anticipated locations at the meeting time, etc.

An embodiment may expand the suggestions based on other, non-user specific data. For example, if an embodiment identifies that a particular restaurant is preferred by a majority of group members, a suggested alternate restaurant may be made by consulting other, community based data, e.g., a like type restaurant that is getting rave reviews from another service.

The illustrated example embodiments will be best understood by reference to the figures. The following description is intended only by way of example, and simply illustrates certain example embodiments.

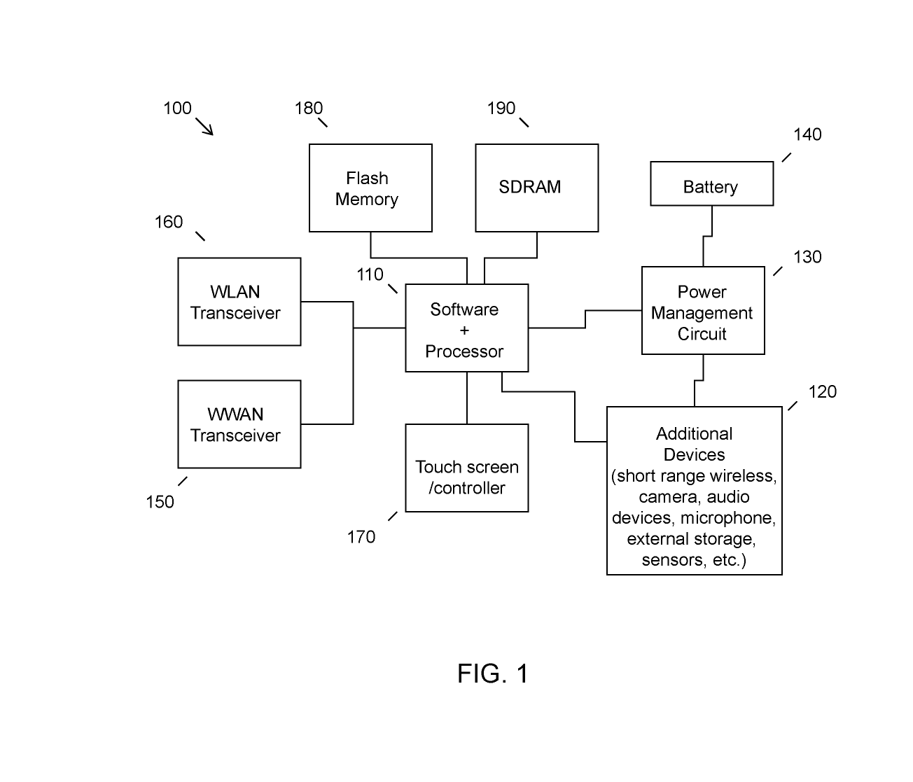

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., a short range wireless device for communicating with other devices, and the like. System 100 often includes a touch screen 170 for data input and display/rendering. System 100 also typically includes various memory devices, for example flash memory 180 and SDRAM 190.

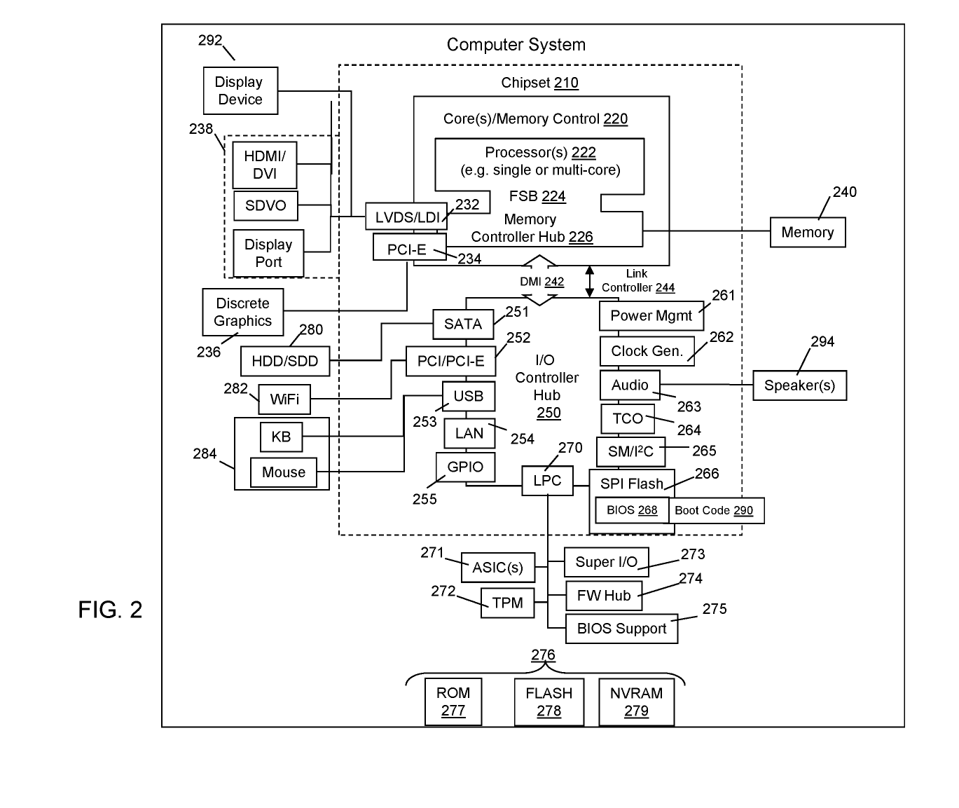

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices that act as personal devices for users. For example, FIG. 1 outlines circuitry that may be used in tablet computer, whereas the circuitry outlined in FIG. 2 may be used in a laptop personal computer. Users operate these personal devices to perform common tasks such as sending messages, setting up calendar appointments, interacting with social media services, streaming video content, making purchases, etc. Thus, such devices may act as sources for contextual data that may be mined to offer consensus suggestions for a linked group of users.

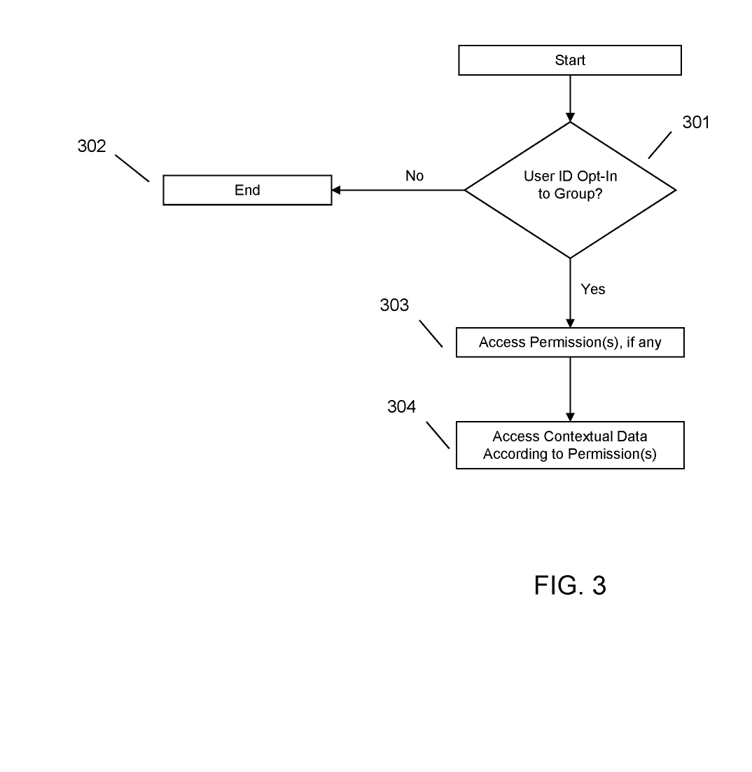

FIG. 3 illustrates an example method of obtaining contextual data from a linked group of users. As described herein, a user may opt-in to sharing contextual data with a service provided by an embodiment. For example, a user may opt-in to join a linked group of users that are attempting to set up a convenient time and location for a work meeting. Thus, an embodiment first determines that a user's identification (e.g., user name, login, device ID, etc.) has opted into data sharing and intends to join a linked group of users, as illustrated at 301. If not, an embodiment will not access that user's contextual data, as illustrated at 302, and that user may or may not be added to the linked group of users. The user may be added to the linked group of users, but not have his or her contextual data consulted in making a suggestion to meet a group objective, e.g., select a convenient time and place for the meeting.

However, if a user does opt-in to joining the linked group of users, this does not mean that any and all of that user's available contextual data is to be mined. Rather, as illustrated at 303, the user may set permissions, i.e., delimit the type and/or amount of contextual data that is made available to the service. For example, a user may select to have a work group of linked users access work calendar data, whereas that user may not wish that work group of linked users to have access to a personal calendar. Thus, an embodiment will access only the data that is indicated by the permissions set by the user, if any, as indicated at 304.

When an embodiment has access to contextual data for some or all of the linked group of users, the contextual data may be used to identify a suggestion for achieving an objective of the group, e.g., in this non-limiting example, selecting a convenient time and place for a work meeting.

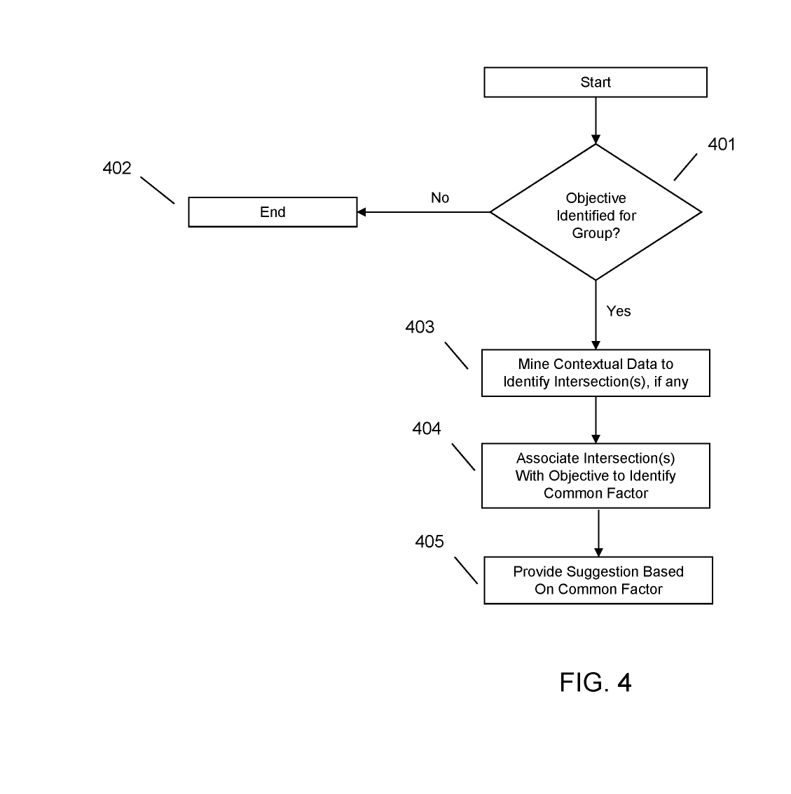

As illustrated in FIG. 4, an embodiment may determine that an object for the linked group of users is identified, as illustrated at 401. This may be as simple as receiving user input from one of the linked group of users that he or she wishes to schedule a meeting with a particular group of users. Alternatively, the objective may be automatically determined or inferred, e.g., by noting that all users within a previously linked group have a tentative meeting time scheduled on their respective calendars.

If no objective is yet present, an embodiment may take no action. However, an embodiment may continue to access contextual data in an effort to identify intersections within the contextual data for later use. An embodiment may also continue to process the groups' contextual data in an effort to automatically identify an objective for the group.

If an objective is identified, as illustrated at 403, an embodiment utilizes data mining of the contextual data to find intersections within the contextual data that relates the users and the objective. For example, an intersection for a common meeting time may be defined as a meeting location joining or overlapping with two meeting points indicated in the users' contextual data, e.g., locations that they frequent at a specific time proposed for the meeting. Specifically, and by way of non-limiting example, User A′s contextual data may indicate that meeting point A is preferred, e.g., based on its proximity to User A′s predicted location at the tentative time for the meeting. User B′s contextual data, on the other hand, may indicate that meeting point B is preferred, e.g., using a similar analysis of location data. An intersection may be defined in this case as an overlap in the data, e.g., location data, indicating that meeting point C is convenient to both User A and User B.

An embodiment will associate, as illustrated at 404, such intersections found within the contextual data of the various users with the objective, in this example a meeting time and location, to identify a common factor. For the location of the meeting, as described herein, a particular meeting point may share a plurality of intersections, and thus be identified as a common factor, as shown at 404. This common factor may be used to form a suggestion for the linked group of users, as illustrated at 405. By way of non-limiting example, meeting point C may be offered as a suggested location that is maximally convenient for the group of linked users as a whole.

An embodiment may of course cycle through the contextual data to offer further refinements to the suggestion, e.g., based on positive or negative feedback input(s) provided by the users. This will assist the linked group of users in finding a consensus decision that has a basis in their specific preferences, etc., i.e., using data that is personally tailored to (and in fact derived from) the members of the linked group of users.

Once a suggestion has been provided, as indicated at 405, an embodiment may continue to update the suggestion, e.g., based on other data sources such as a community database that is not specifically related to the users. This may assist in navigating around conflicts found in the users' contextual data precluding a consensus suggestion. For example, a public meeting location that is identified as an initial suggestion may be changed, e.g., based on community wide ratings for that or similar public meeting locations.

In an embodiment, the group of linked users may be temporary. For example, after a project has been completed, a gift has been purchased, an agreed upon meeting time has past, or another objective has been achieved, per the suggestion provided at 405, an embodiment may disband the group. Alternatively, the group may persist, particularly if there is a periodic need to form a consensus, e.g., a group that meets quarterly may form a persistent group of linked users.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
accessing, using a processor, contextual data sources specific to a linked group of users;
identifying, using a processor, an objective for the linked group of users;
determining, based on the objective, a common factor among the linked group of users based on the contextual data sources; and
providing, based on the common factor, a suggestion associated with achieving the objective.

2. The method of claim 1, wherein the linked group of users is a temporary group.

3. The method of claim 1, wherein the detecting comprises detecting one or more permissions associated with a user of the linked group of users, said permissions acting to delimit contextual data sources used in association with the user.

4. The method of claim 1, wherein the contextual data sources comprise data selected from the group consisting of social media data, message data, calendar data, and transactional data.

5. The method of claim 1, wherein the objective is identified by input received from one of the linked group of users.

6. The method of claim 1, wherein the objective is automatically identified.

7. The method of claim 6, wherein the objective is automatically identified using calendar data of at least one of the linked group of users.

8. The method of claim 1, further comprising accessing a data source not specifically associated with the linked group of users;
wherein the suggestion is based on the common factor and the data source not specifically associated with the linked group of users.

9. The method of claim 8, wherein the data source not specifically associated with the linked group of users comprises a community data source.

10. The method of claim 1, wherein the suggestion is selected from the group consisting of a meeting location, a meeting time, a group gift, a menu, and a group activity.

11. A device, comprising:
a processor; and
a memory device that stores instructions executable by the processor to:
access contextual data sources specific to a linked group of users;
identify an objective for the linked group of users;
determine, based on the objective, a common factor among the linked group of users based on the contextual data sources; and
provide, based on the common factor, a suggestion associated with achieving the objective.

12. The device of claim 11, wherein the linked group of users is a temporary group.

13. The device of claim 11, wherein the instructions executable by the processor to detect comprises instructions that detect one or more permissions associated with a user of the linked group of users, said permissions acting to delimit contextual data sources used in association with the user.

14. The device of claim 11, wherein the contextual data sources comprise data selected from the group consisting of social media data, message data, calendar data, and transactional data.

15. The device of claim 11, wherein the objective is identified by input received from one of the linked group of users.

16. The device of claim 11, wherein the objective is automatically identified.

17. The device of claim 16, wherein the objective is automatically identified using calendar data of at least one of the linked group of users.

18. The device of claim 11, further comprising accessing a data source not specifically associated with the linked group of users;
wherein the suggestion is based on the common factor and the data source not specifically associated with the linked group of users.

19. The device of claim 18, wherein the data source not specifically associated with the linked group of users comprises a community data source.

20. A product, comprising:
a storage device having code stored therewith, the code being executable by a processor and comprising:
code that accesses contextual data sources specific to a linked group of users;
code that identifies an objective for the linked group of users;
code that determines, based on the objective, a common factor among the linked group of users based on the contextual data sources; and
code that provides, based on the common factor, a suggestion associated with achieving the objective.
